(19) United States
(12) Patent Application Publication
(10) Pub. No.: US 2019/0124723 A1
(43) Pub. Date: Apr. 25, 2019

(54) THERMISTOR HEATER WITH HEAT DISSIPATION STRUCTURE AND ASSEMBLING METHOD THEREOF

(71) Applicant: BETACERA INC., New Taipei City (TW)

(72) Inventors: Etsuro Habata, New Taipei City (TW); Chih-Chang WEI, New Taipei City (TW)

(21) Appl. No.: 15/792,646

(22) Filed: Oct. 24, 2017

(51) Int. Cl. H05B 3/14; H05B 3/50; H05B 3/20

(52) U.S. Cl. CPC H05B 3/14; H05B 3/50; H05B 2203/017; H05B 2203/02; H05B 2203/023; H05B 3/20

(57) ABSTRACT

A thermistor heater includes a thermistor module, a first heat dissipation member and a second heat dissipation member. An adhesive is coated onto a side facing the thermistor module, and the adhesive overflown from a position between the first heat dissipation member, thermistor module and second heat dissipation member encloses a peripheral surface of the joint of the first heat dissipation member, thermistor module and second heat dissipation member to simplify the assembling process of the thermistor heater. This disclosure further provides an assembling method of the thermistor heater with a heat dissipation structure.

### FIELD OF THE INVENTION

This disclosure generally relates to the field of electric heaters, and more particularly to a thermistor heater.

### BACKGROUND OF THE INVENTION

In general, an electric heater carries out a heating process according to the principle of converting electric energy into heat energy directly, and there is a resistive electric heater such as a thermistor heater that generates heat by the resistance of a conductor for the heating process, wherein the resistance changes with a change of temperature, and a thermistor with the resistance increasing with the temperature is called a positive temperature coefficient (PTC) thermistor.

In the structure of a conventional PTC thermistor heater, several PTC heaters are installed into an insulating base to form a PTC heating module. In addition, a thermally conductive fin assembly is generally installed on both sides of the PTC heating module for conducting the generated heat to the outside. However, the conventional thermally conductive fin assembly is installed by coating an adhesive on a side of the fin assembly that faces the PTC heater, and sticking the fin assembly onto a side of the PTC heater. After the adhesive is cured, the same manufacturing procedure is applied to stick another thermally conductive fin assembly onto the other side of the PTC heater. After the thermally conductive fin assembly is adhered and fixed, an insulating adhesive is finally applied to seal the periphery of the insulating base to prevent external water vapor from entering.

Since the adhesive is applied between the PTC heater and the thermally conductive fin assembly for several times and it takes a long time to cure the adhesive, the assembling process is cumbersome and lengthy. Obviously, improvements are required.

In view of the aforementioned drawbacks of the prior art, the discloser of this disclosure based on years of experience to conduct extensive research and experiment, and finally provided a feasible solution to overcome the drawbacks of the prior art.

### SUMMARY OF THE INVENTION

Therefore, it is a primary objective of this disclosure to provide a thermistor heater with a heat dissipation structure and its assembling method to reduce the time of curing the adhesive and simplify the assembling process.

To achieve the aforementioned and other objectives, this disclosure provides a thermistor heater with a heat dissipation structure, comprising: a thermistor module, a first heat dissipation member, a first adhesive layer, a second heat dissipation member and a second adhesive layer. The thermistor module has a first surface and a second surface opposite to each other; the first heat dissipation member is installed on first surface and has a first heat dissipation surface facing the thermistor module, and the first heat dissipation surface has a surrounding size expanding outwardly with respect to the surrounding size of the first surface to define a first adhesive area, and the first adhesive layer is disposed between the first surface and the first heat dissipation surface; the second heat dissipation member is installed on the second surface and has a second heat dissipation surface facing the thermistor module, and the second heat dissipation surface has a expanding outwardly with respect to the surrounding size of the second surface to define a second adhesive area, and the second adhesive layer is disposed between the second surface and the second heat dissipation surface; wherein, the first adhesive layer overflown from a position between the first surface and the first heat dissipation surface and the second adhesive layer overflown from a position between the second surface and the second heat dissipation surface jointly fill up the first adhesive area and the second adhesive area to enclose the peripheral surface of the joint of the first heat dissipation member, the thermistor module and the second heat dissipation member.

To achieve the aforementioned and other objectives, this disclosure also provides an assembling method of a thermistor heater with a heat dissipation structure, comprising the steps of: providing a thermistor module, a first heat dissipation member and a second heat dissipation member; coating an a first adhesive layer with an adhesive quantity of at least 0.02 to 0.03 g/cm2 uniformly onto a side of the first heat dissipation member facing the thermistor module;

coating an a second adhesive layer with an adhesive quantity of at least 0.02 to 0.03 g/cm2 uniformly onto a side of the second heat dissipation member facing the thermistor module; and laminating the first heat dissipation member and the second heat dissipation member to both opposite sides of the thermistor module respectively, wherein, after the first adhesive layer and the second adhesive layer are laminated, the first and second adhesives are overflown to cover the periphery of the joint of the thermistor module, the first heat dissipation member and the second heat dissipation member, and the assembling of the thermistor heater with a heat dissipation structure is completed at one time after the first adhesive layer and the second adhesive layer are cured.

Compared with the prior art, the thermistor heater with a heat dissipation structure and its assembling method in accordance with this disclosure include coating the adhesives with a quantity of at least 0.02 to 0.03 g/cm² onto the sides of the first heat dissipation member and the second heat dissipation member facing the thermistor module respectively, and laminating the first heat dissipation member and the second heat dissipation member onto the opposite sides of the thermistor module, so that the adhesives are overflown to cover the periphery of the joint of the thermistor module, the first heat dissipation member and the second heat dissipation member to achieve the effect of simplifying the assembling of the thermistor heater.

### BRIEF DESCRIPTION OF THE DRAWINGS

FIG. 1 is an exploded view of a thermistor heater with a heat dissipation structure of this disclosure;

FIG. 2 is a perspective view of a thermistor heater with a heat dissipation structure of this disclosure;

FIG. 3 is a cross-sectional side view of a thermistor heater with a heat dissipation structure of this disclosure;

FIG. 4 is another cross-sectional side view of a thermistor heater with a heat dissipation structure of this disclosure;

FIG. 5 shows another implementation mode of a thermistor module of this disclosure; and

FIG. 6 is a flow chart of an assembling method of a thermistor heater with a heat dissipation structure of this disclosure.

### DESCRIPTION OF THE PREFERRED EMBODIMENTS

The technical contents of this disclosure will become apparent with the detailed description of preferred embodiments accompanied with the illustration of related drawings as follows. It is noteworthy that same numerals are used for representing same respective elements in the drawings.

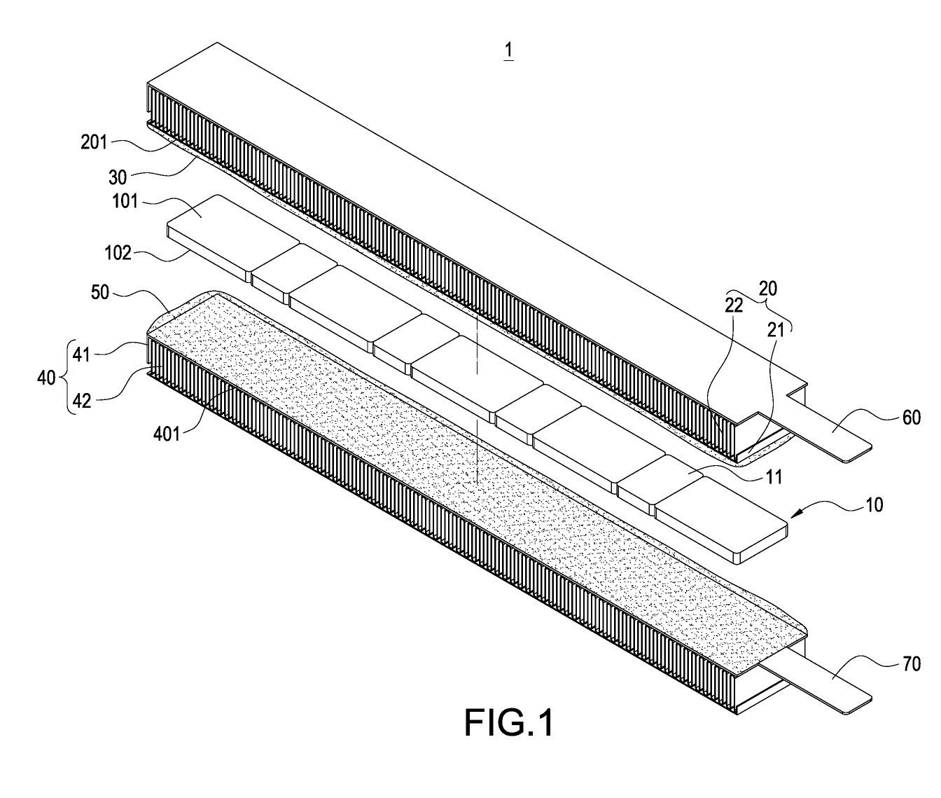

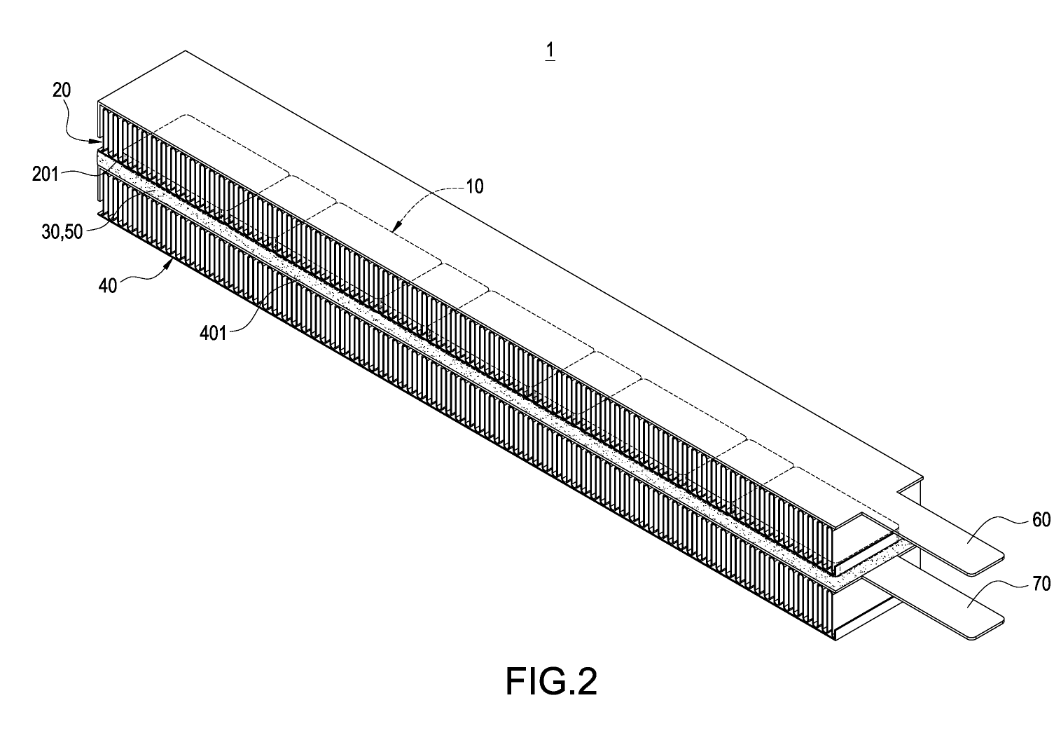

With reference to FIGS. 1 to 4 for the exploded view, perspective view and cross-sectional side views of a thermistor heater with a heat dissipation structure in accordance with this disclosure respectively, the thermistor heater with a heat dissipation structure 1 as shown in FIGS. 1 and 2 comprises a thermistor module 10, a first heat dissipation member 20, a first adhesive layer 30, a second heat dissipation member 40 and a second adhesive layer 50. The first heat dissipation member 20 is combined to a side of the thermistor module 10 through the first adhesive layer 30; and the second heat dissipation member 40 is combined to the other side of the thermistor module 10 through the second adhesive layer 50 to constitute the thermistor heater 1. The structure of the thermistor heater 1 will be described in details below.

The thermistor module 10 is a positive temperature coefficient (PTC) thermistor. The principle and structure of the thermistor module 10 are prior art, and thus they will not be described here. In this preferred embodiment, the thermistor module 10 includes a plurality of thermistor units 11 coupled to one another, and the thermistor module 10 has a first surface 101 and a second surface 102 disposed opposite to each other.

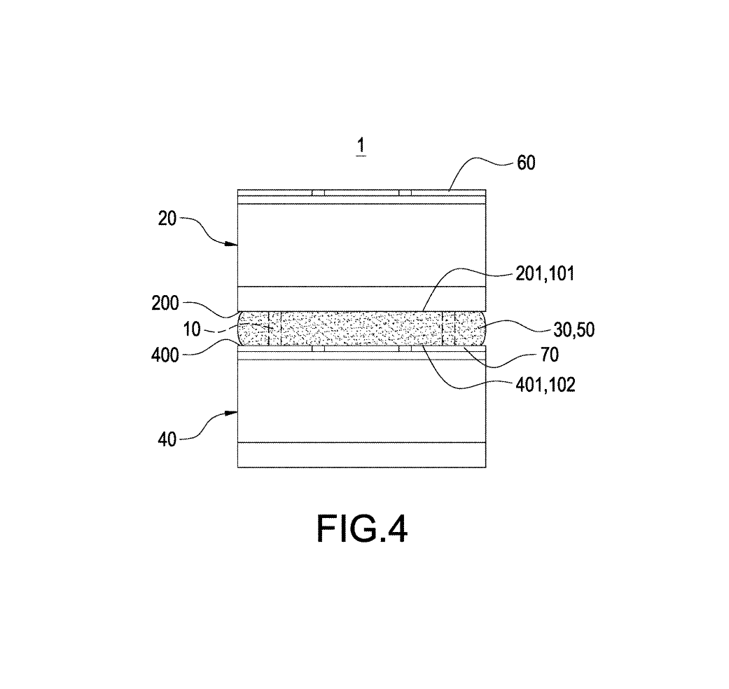

The first heat dissipation member 20 is installed on the first surface 101 and has a first heat dissipation surface 201 facing the thermistor module 10. The first heat dissipation surface 201 has a surrounding size expanding outwardly with respect to the surrounding size of the first surface 101 to define a first adhesive area 200 (as shown in FIG. 4). Specifically, the first heat dissipation surface 201 has a surrounding size expanding outwardly for 0.3 mm to 0.5 mm (preferably 0.4 mm) with respect to the surrounding size of the first surface 101.

In this preferred embodiment, the first heat dissipation member 20 is a first fin module including a first thermal conduction plate 21 attached to the thermistor module 10 and a first wavy fin 22 installed on the first thermal conduction plate 21.

The first adhesive layer 30 is disposed between the first surface 101 and the first heat dissipation surface 201. In this preferred embodiment, a first adhesive layer 30 with an adhesive quantity of at least 0.02 to 0.03 g/cm² is coated uniformly onto a side of the first heat dissipation member 20 facing the thermistor module 10.

In addition, the second heat dissipation member 40 is installed on the second surface 102 and has a second heat dissipation surface 401 facing the thermistor module 10. The second heat dissipation surface 401 has a surrounding size expanding outwardly with respect to the surrounding size of the second surface 102 to define a second adhesive area 400 (as shown in FIG. 4). Specifically, the second heat dissipation surface 401 has a surrounding size expanding outwardly for 0.3 mm to 0.5 mm (preferably 0.4 mm) with respect to the surrounding size of the second surface 102.

In this preferred embodiment, the second heat dissipation member 40 is a second fin module including a second thermal conduction plate 41 attached to the other side of the thermistor module 10 and a second wavy fin 42 installed on the second thermal conduction plate 41.

In addition, the second adhesive layer 50 is disposed between the second surface 102 and the second heat dissipation surface 401. In this preferred embodiment, the second heat dissipation member 40 has a second adhesive layer 50 with an adhesive quantity of at least 0.02 to 0.03 g/cm² is coated uniformly onto a side facing the thermistor module 10.

Preferably, the first adhesive layer 30 and the second adhesive layer 50 are Q3-6611 adhesives with a viscosity of 80000 mPa·s to 90000 mPa·s (preferably 86000 mPa·s), but this disclosure is not limited to such arrangement only. It is noteworthy that the first heat dissipation member 20 and the second heat dissipation member 40 are laminated onto the opposite sides of the thermistor module 10 respectively by a pressure of 11 to 17 kg/cm^{2, and} the first adhesive layer 30 and the second adhesive layer 50 with the aforementioned viscosity, adhesive quantity and pressure provides a better covering effect.

In this preferred embodiment, the thermistor heater 1 further comprises a first electrode plate 60 and a second electrode plate 70, and both of the first electrode plate 60 and the second electrode plate 70 are electrically coupled to the thermistor module 10 for connecting external power.

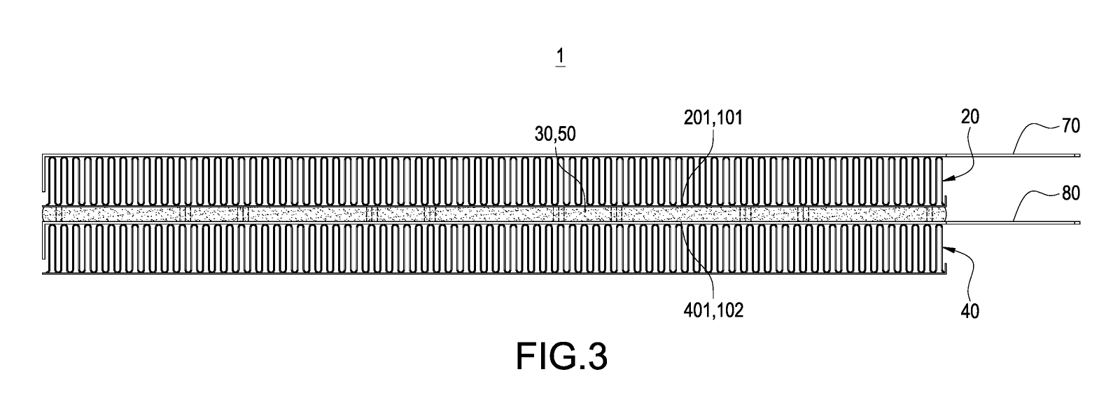

With reference to FIGS. 3 and 4, when the first heat dissipation member 20 and the second heat dissipation member 40 are laminated onto the opposite sides of the thermistor module 10 respectively by a pressure of 11 to 17 kg/cm², the first adhesive layer 30 overflown from a position between the first surface 101 and the first heat dissipation surface 201 and the second adhesive layer 50 overflown from a position between the second surface 102 and the second heat dissipation surface 401 jointly fill up the first adhesive area 200 and the second adhesive area 400 to enclose the peripheral surface of the joint of the first heat dissipation member 20, the thermistor module 10 and the second heat dissipation member 40.

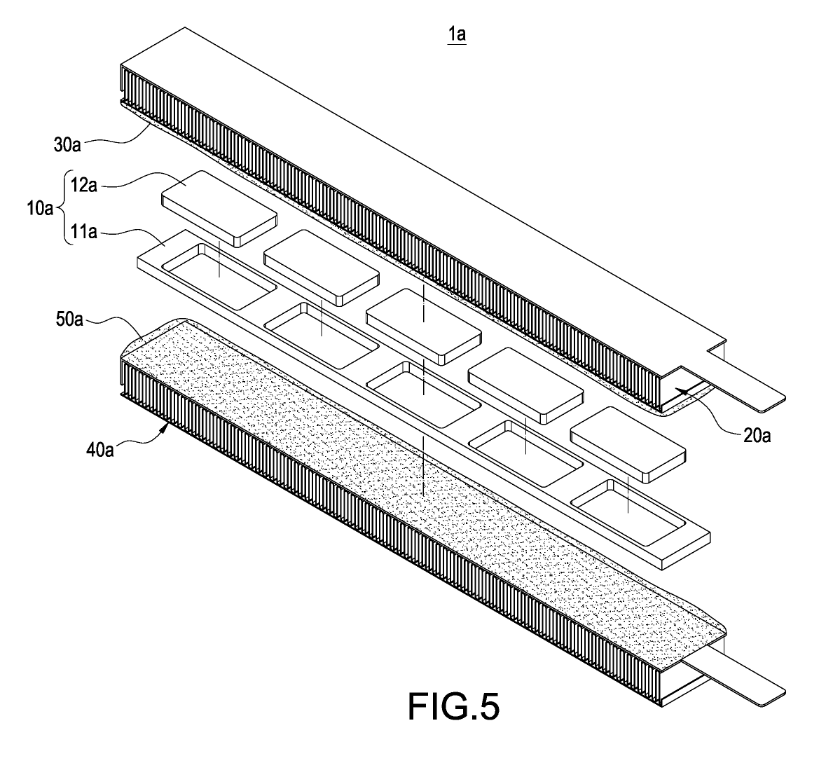

With reference to FIG. 5 for another implementation mode of the thermistor module of this disclosure, the thermistor heater 1a comprises a thermistor module 10a, a first heat dissipation member 20a, a first adhesive layer 30a, a second heat dissipation member 40a and a second adhesive layer 50a.

In this preferred embodiment, the thermistor heater 1a is substantially the same as the thermistor heater 1 of the previous preferred embodiment, except the assembly of the thermistor module 10a. In this preferred embodiment, the thermistor module 10a comprises an insulating frame 11a and a plurality of thermistor units 12a installed apart with each other in the insulating frame 11a. In addition, the method of assembling the thermistor heater 1a is the same as that of the previous preferred embodiment, and thus will not be repeated.

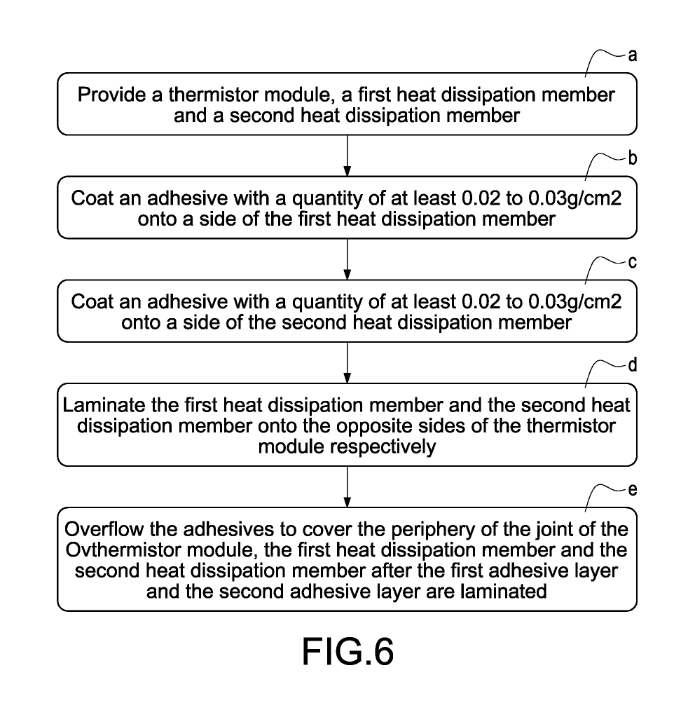

With reference to FIG. 6 for a flow chart of an assembling method of a thermistor heater with a heat dissipation structure in accordance with this disclosure, the method comprises the following steps:

Step (a): Provide a thermistor module 10, a first heat dissipation member 20 and a second heat dissipation member 40.

Step (b): Coat a first adhesive layer 30 with an adhesive quantity of at least 0.02 to 0.03 g/cm² uniformly onto a side of the first heat dissipation member 20 facing the thermistor module 10.

Step (c): Coat a second adhesive layer 50 with an adhesive quantity of at least 0.02 to 0.03 g/cm² uniformly onto a side of the second heat dissipation member 20 facing the thermistor module 10.

Step (d): Laminate the first heat dissipation member 20 and the second heat dissipation member 40 onto the opposite sides of the thermistor module 10 respectively.

Step (e): Overflow the adhesives to cover the periphery of the joint of the thermistor module 10, the first heat dissipation member 20 and the second heat dissipation member 40 after the first adhesive layer 30 and the second adhesive layer 50 are laminated, and complete assembling the thermistor heater with a heat dissipation structure 1 at one time after the first adhesive layer 30 and the second adhesive 50 are cured.

While this disclosure has been described by means of specific embodiments, numerous modifications and variations could be made thereto by those skilled in the art without departing from the scope and spirit of this disclosure set forth in the claims.

What is claimed is:

1. A thermistor heater with a heat dissipation structure, comprising:
a thermistor module, having a first surface and a second surface opposite to each other;
a first heat dissipation member, installed on the first surface, and having a first heat dissipation surface facing the thermistor module, and the first heat dissipation surface having a surrounding size expanding outwardly with respect to the surrounding size of the first surface to define a first adhesive area;
a first adhesive layer, disposed between the first surface and the first heat dissipation surface;
a second heat dissipation member, installed on the second surface, and having a second heat dissipation surface facing the thermistor module, and the second heat dissipation surface having a surrounding size expanding outwardly with respect to the surrounding size of the second surface to define a second adhesive area; and
a second adhesive layer, disposed between the second surface and the second heat dissipation surface;
wherein, the first adhesive layer overflown from a position between the first surface and the first heat dissipation surface and the second adhesive layer overflown from a position between the second surface and the second heat dissipation surface jointly fill up the first adhesive area and the second adhesive area to enclose the peripheral surface of the joint of the first heat dissipation member, the thermistor module and the second heat dissipation member.

2. The thermistor heater with a heat dissipation structure according to claim 1, wherein the first heat dissipation surface has a surrounding size expanding outwardly for 0.3 mm to 0.5 mm with respect to the surrounding size of the first surface; and the second heat dissipation surface has a surrounding size expanding outwardly for 0.3 mm to 0.5 mm with respect to the surrounding size of the second surface.

3. The thermistor heater with a heat dissipation structure according to claim 1, wherein the thermistor module includes an insulating frame and a plurality of thermistor units installed apart from each other in the insulating frame.

4. The thermistor heater with a heat dissipation structure according to claim 1, wherein the first heat dissipation member is a first fin module including a first thermal conduction plate attached to a side of the thermistor module and a first wavy fin installed on the first thermal conduction plate; and the second heat dissipation member is a second fin module including a second thermal conduction plate attached to the other side of the thermistor module and a second wavy fin installed on the second thermal conduction plate.

5. The thermistor heater with a heat dissipation structure according to claim 1, wherein the first adhesive layer and the second adhesive layer are coated with an adhesive with a quantity of at least 0.02 to 0.03 g/cm²; and the first heat dissipation member and the second heat dissipation member are laminated on the thermistor module by a pressure of 11 to 17 kg/cm².

6. The thermistor heater with a heat dissipation structure according to claim 1, wherein the first adhesive layer and the second adhesive layer have a viscosity of 80000 mPa·s to 90000 mPa·s.

7. An assembling method of a thermistor heater with a heat dissipation structure, comprising the steps of:
providing a thermistor module, a first heat dissipation member and a second heat dissipation member;
coating an a first adhesive layer with an adhesive quantity of at least 0.02 to 0.03 g/cm² uniformly onto a side of the first heat dissipation member facing the thermistor module;
coating an a second adhesive layer with an adhesive quantity of at least 0.02 to 0.03 g/cm² uniformly onto a side of the second heat dissipation member facing the thermistor module;
laminating the first heat dissipation member and the second heat dissipation member to both opposite sides of the thermistor module respectively; and
overflowing the first and second adhesives after the first adhesive layer and the second adhesive layer are laminated, and covering the periphery of the joint of the thermistor module, the first heat dissipation member and the second heat dissipation member by the overflown adhesives, and completing the assembling of the thermistor heater with a heat dissipation structure at one time after the first adhesive layer and the second adhesive layer are cured.

8. The assembling method of a thermistor heater with a heat dissipation structure according to claim 7, wherein the thermistor module has a first surface and a second surface opposite to each other, and the first heat dissipation member has a first heat dissipation surface facing the thermistor module, and the first heat dissipation surface has a surrounding size expanding outwardly for 0.3 mm to 0.5 mm with respect to the surrounding size of the first surface; and the second heat dissipation member has a second heat dissipation surface facing the thermistor module, and the second heat dissipation surface has a surrounding size expanding outwardly for 0.3 mm to 0.5 mm with respect to the surrounding size of the second surface.

9. The assembling method of a thermistor heater with a heat dissipation structure according to claim 8, wherein the first heat dissipation surface has a surrounding size expanding outwardly for 0.4 mm with respect to the surrounding size of the first surface; and the second heat dissipation surface has a surrounding size expanding outwardly for 0.4 mm with respect to the surrounding size of the second surface.

10. The assembling method of a thermistor heater with a heat dissipation structure according to claim 7, wherein the first heat dissipation member and the second heat dissipation member are laminated on the thermistor module by a pressure of 11 to 17 kg/cm².

11. The assembling method of a thermistor heater with a heat dissipation structure according to claim 7, wherein the first heat dissipation member is a first fin module including a first thermal conduction plate attached to the thermistor module and a first wavy fin installed on the first thermal conduction plate; and the second heat dissipation member is a second fin module including a second thermal conduction plate attached to the other side of the thermistor module, and a second wavy fin installed on the second thermal conduction plate.

12. The assembling method of a thermistor heater with a heat dissipation structure according to claim 7, wherein the first adhesive layer and the second adhesive layer have a viscosity of 80000 mPa·s to 90000 mPa·s.
